(19) United States
(12) Patent Application Publication
(10) Pub. No.: US 2025/0377720 A1
(43) Pub. Date: Dec. 11, 2025

(54) OBSERVER-BASED VIEWS ON EXTERNAL FACING DISPLAYS

(71) Applicant: Apple Inc., Cupertino, CA (US)

(72) Inventors: Gilles M Cadet, Agoura Hills, CA (US); Justin A Meiners, Boulder, CO (US); Pavel V Dudrenov, San Francisco, CA (US); Seung Wook Kim, San Jose, CA (US); Felipe Bacim de Araujo e Silva, San Jose, CA (US); Alfred B Huergo Wagner, Redwood City, CA (US)

(21) Appl. No.: 19/201,316

(22) Filed: May 7, 2025

Related U.S. Application Data
(60) Provisional application No. 63/657,357, filed on Jun. 7, 2024.

(51) Int. Cl. G06F 3/01; G06T 15/20

(52) U.S. Cl. CPC G06F 3/013; G06F 3/012; G06T 15/20

(57) ABSTRACT

Various implementations implement a process for rendering a view of a three-dimensional (3D) representation on an external facing display of a head mounted device (HMD) based on determining observer-based viewing characteristics. For example, a method may include obtaining a 3D representation of at least a portion of a head of a user (e.g., face or eye region), as the user is wearing the HMD in a physical environment. The method may further include determining an observer-based viewing characteristic (e.g., vertical viewing angle or the like) corresponding to one or more vertical viewing angles of one or more observers relative to the HMD in the physical environment, the one or more vertical viewing angles determined based on sensor data obtained via the one or more sensors The method may further include rendering a view of the 3D representation on the external facing display based on the observer-based viewing characteristic.

### CROSS-REFERENCE TO RELATED APPLICATIONS

This application claims the benefit of U.S. Provisional Application Ser. No. 63/657,357 filed Jun. 7, 2024, which is incorporated herein in its entirety.

### TECHNICAL FIELD

The present disclosure generally relates to electronic devices that provide views of three-dimensional (3D) representations on an external facing display.

### BACKGROUND

It may be desirable to generate and display a three-dimensional (3D) representation of a portion of a user on an external facing display of a device, while a user is using and/or wearing a device, such as a head mounted device (HMD). However, existing systems may not adjust the display of the 3D representation corresponding to one or more observer-based views.

### SUMMARY

Various implementations disclosed herein include devices, systems, and methods that provide views of three-dimensional (3D) representation of a portion of a user on an external facing display of a device worn by a user, such as a head mounted device (HMD). In some implementations, the views of the portion of the user depict an eye region such as the eyes and surrounding face around the eyes. In some implementations, the views of the eye region are generated and adjusted to account for a vertical viewing angle for an observer relative to a display or render direction. Thus, the views of the eye region better align with the user's actual eye region from the viewpoint of the observer. For example, the user's eyes appear to the observer(s) to be in the right place behind the HMD rather than appearing to be too high or too low on the user's face. In other words, the method applies a software-based vertical parallax correction to provide a more realistic positioning of the depiction of the user eye region for an observer.

Additionally, various implementations disclosed herein include devices, systems, and methods that provide a 3D representation of a user's face that is generated (e.g., based on prior and/or current sensor data of the user's face) and the views of the 3D representation are rendered based on a render camera position (e.g., directly in front of the HMD display) and an adjustment that is based on observer vertical viewing angle.

In some implementations, the adjustment may involve determining an offset using a parallax plane. Some implementations account for different vertical viewing angles of multiple observers by making adjustments using an average vertical viewing angle or a weighted average vertical viewing angle (e.g., weighted based on proximity to the HMD). Some implementations account for different vertical viewing angles of multiple observers by applying a different adjustment for each observer. For example, each observer may see a different view provided by a lenticular display on an HMD that can display different views to different horizontal viewing angles. In some implementations, each such view may be adjusted based on the respective observer's vertical viewing angle. Some implementations additionally dim the views based on the vertical viewing angle. For example, increasing dimming for larger vertical viewing angle views.

In some implementations, the parallax effect may supplement a 3D effect provided by a lenticular display (e.g., hybrid 3D effect). For example, the parallax effect may be designed to supplement the 3D effect provided by a lenticular display. Cylindrical lenticular lenses may only provide a 3D effect on one axis, so the parallax effect may help supplement the 3D effect on the other axis. In other words, providing a parallax effect provides a hybrid 3D effect.

In general, one innovative aspect of the subject matter described in this specification can be embodied in methods, at a processor of a head mounted device (HMD) that includes one or more sensors and an external facing display, that include the actions of obtaining a three-dimensional (3D) representation of at least a portion of a head of a user, where the user is wearing the HMD in a physical environment. The actions further include determining an observer-based viewing characteristic corresponding to one or more vertical viewing angles of one or more observers relative to the HMD in the physical environment, the one or more vertical viewing angles determined based on sensor data obtained via the one or more sensors. The actions further include rendering a view of the 3D representation on the external facing display, the view of the 3D representation rendered based on the observer-based viewing characteristic.

These and other embodiments can each optionally include one or more of the following features.

In some aspects, rendering the view of the 3D representation on the external facing display includes adjusting a vertical offset based on the observer-based viewing characteristic. In some aspects, rendering the view of the 3D representation on the external facing display includes determining a parallax plane as a proxy for the 3D representation.

In some aspects, the one or more vertical viewing angles of the one or more observers is relative to a plane of the external facing display. In some aspects, the one or more vertical viewing angles of the one or more observers is updated at a first frequency, and wherein the view of the 3D representation is rendered based on the observer-based viewing characteristic at a second frequency that is higher than the first frequency.

In some aspects, the actions further include modifying the view of the 3D representation on the external facing display based on determining that there are two or more observers of the HMD. In some aspects, modifying the view of the 3D representation based on determining that there are two or more observers of the HMD includes determining an average vertical viewing angle of the two or more observers, and adjusting the view of the 3D representation on the external facing display based on the average vertical viewing angle of each observer. In some aspects, modifying the view of the 3D representation based on determining that there are two or more observers of the HMD includes identifying a priority observer of the two or more observers based on one or more criterion, and modifying the view of the 3D representation on the external facing display based on a viewing angle corresponding to the identified priority observer.

In some aspects, the actions further include modifying a first view of the 3D representation on the external facing display for a first observer of the one or more observers, and modifying a second view of the 3D representation on the external facing display for a second observer of the one or more observers, wherein the second view is a different view than the first view.

In some aspects, the actions further include modifying the view of the 3D representation on the external facing display based on determining that at least one observer the one or more observers are within an observation region of the HMD. In some aspects, the actions further include determining an amplitude of a first vertical viewing angle corresponding to a first observer, and modifying the view of the 3D representation on the external facing display by adjusting a level of luminance for the view of the 3D representation based on the determined amplitude of the first vertical viewing angle.

In some aspects, the actions further include determining that an amplitude of a first vertical viewing angle corresponding to a first observer exceeds a threshold, and in response to determining that the amplitude of the first vertical viewing angle corresponding to the first observer exceeds a threshold, modifying the view of the 3D representation on the external facing display by providing content corresponding to the 3D representation at one or more edges of the external facing display.

In some aspects, the sensor data associated with determining the one or more vertical viewing angles includes at least one of location data and image data corresponding to the one or more observers. In some aspects, determining the observer-based viewing characteristic corresponding to the one or more vertical viewing angles of the one or more observers relative to the HMD in the physical environment is based on determining a scene understanding of the physical environment.

In some aspects, the 3D representation represents a region around the eyes of the user. In some aspects, the HMD includes one or more outward facing image sensors, and wherein the one or more vertical viewing angles are determined based on sensor data captured by the one or more outward facing image sensors.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an example of multiple devices and respective users within a physical environment, in accordance with some implementations.

FIG. 2 illustrates an example of generating a three-dimensional (3D) representation of an eye region based on enrollment data, in accordance with some implementations.

FIG. 3 illustrates an example of generating a 3D representation of an eye region based on dynamic texturing on a static mesh, in accordance with some implementations.

FIG. 4 illustrates an example of generating a 3D representation of an eye region based on dynamic texturing and static UVs on a static mesh, in accordance with some implementations.

FIG. 5 illustrates an example of determining a vertical parallax offset correction based on an observer-based viewing characteristic, in accordance with some implementations.

FIG. 6 illustrates an example of adjusting a view of a 3D representation on the external facing display based on a vertical offset, in accordance with some implementations.

FIG. 7 illustrates exemplary electronic devices and respective users in the same physical environment and determining observer-based viewpoints in accordance with some implementations.

FIG. 8 is a process flow chart illustrating an exemplary process for rendering a view of a 3D representation on an external facing display based on a determined observer-based viewing characteristic, in accordance with some implementations.

FIG. 9 is a block diagram of an electronic device of in accordance with some implementations.

FIG. 10 is a block diagram of a head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

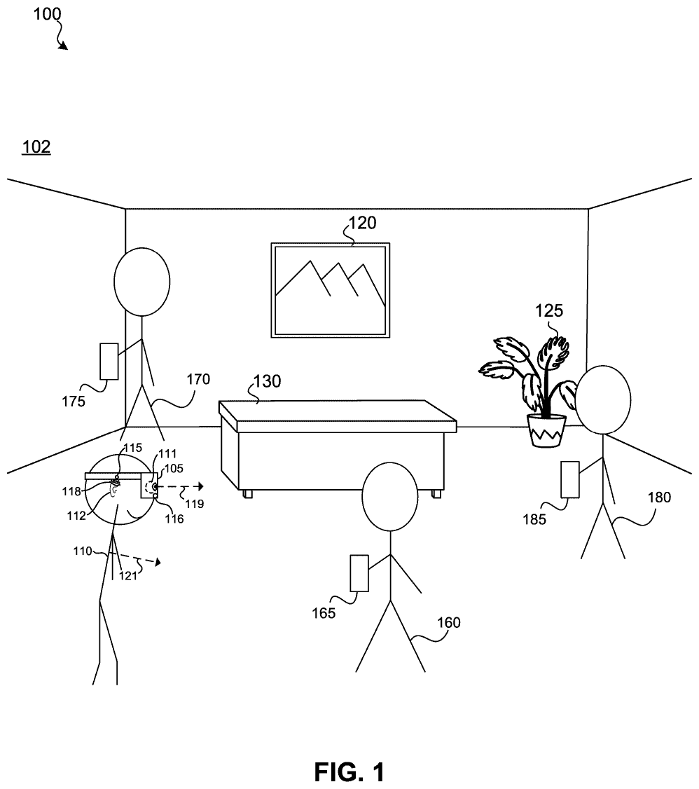

FIG. 1 illustrates an example environment 100 of exemplary electronic devices 105, 165, 175, and 185 operating in a physical environment 102. In some implementations, electronic devices 105, 165, 175, and 185 may be able to share information with one another or an intermediary device such as an information system. Additionally, physical environment 102 includes user 110 wearing device 105, observer 160 holding device 165, observer 170 holding device 175, and observer 180 holding device 185. In some implementations, the devices are configured to present views of an extended reality (XR) environment, which may be based on the physical environment 102, and/or include added content such as virtual elements providing text narrations.

In the example of FIG. 1, the physical environment 102 is a room that includes physical objects such as wall hanging 120, plant 125, and desk 130. Each electronic device 105, 165, 175, and 185 may include one or more cameras, microphones, depth sensors, motion sensors, or other sensors that can be used to capture information about and evaluate the physical environment 102 and the objects within it, as well as information about user 110 and each observer 160, 170, and 180 of the electronic devices 105, 165, 175, and 185, respectively.

In the example of FIG. 1, the first device 105 includes one or more sensors 116 that capture light-intensity images, depth sensor images, audio data or other information about the user 110 (e.g., internally facing sensors and externally facing cameras). For example, the one or more sensors 116 may capture images of the user's (e.g., user 110) forehead, eyebrows, eyes, eye lids, cheeks, nose, lips, chin, face, head, hands, wrists, arms, shoulders, torso, legs, or other body portion. For example, internally facing sensors may see what's inside of the device 105 (e.g., the user's eyes and around the eye area), and other external cameras may capture the user's face outside of the device 105 (e.g., egocentric cameras that point toward the user 110 outside of the device 105). Sensor data about a user's eye 111, as one example, may be indicative of various user characteristics, e.g., the user's gaze direction 119 over time, user saccadic behavior over time, user eye dilation behavior over time, etc. The one or more sensors 116 may capture audio information including the user's speech and other user-made sounds as well as sounds within the physical environment 100.

Additionally, the one or more sensors 116 may capture images of the physical environment 100 (e.g., externally facing sensors). For example, the one or more sensors 116 may capture images of the physical environment 100 that includes physical objects such as wall hanging 120, plant 125, and desk 130. Moreover, the one or more sensors 116 may capture images (e.g., light intensity images and/or depth data) that includes one or more portions of the other observer's 160, 170, 180. In exemplary embodiments, the observer's 160, 170, and 180 may be referred to herein as “observers” with respect to device 105 and/or user 110. In other words, observer 160, observer 170, and/or observer 180 may be observing an external facing display of device 105 (e.g., a displayed 3D representation of user's 110 eye 111), as further discussed herein.

One or more sensors, such as one or more sensors 115 on device 105, may identify user information based on proximity or contact with a portion of the user 110. As example, the one or more sensors 115 may capture sensor data that may provide biological information relating to a user's cardiovascular state (e.g., pulse), body temperature, breathing rate, etc.

The one or more sensors 116 or the one or more sensors 115 may capture data from which a user orientation 121 within the physical environment can be determined. In this example, the user orientation 121 corresponds to a direction that a torso of the user 110 is facing.

Some implementations disclosed herein determine a user understanding based on sensor data obtained by a user worn device, such as first device 105. Such a user understanding may be indicative of a user state that is associated with providing user assistance. In some example, a user's appearance or behavior or an understanding of the environment may be used to recognize a need or desire for assistance so that such assistance can be made available to the user. For example, based on determining such a user state, augmentations may be provided to assist the user by enhancing or supplementing the user's abilities, e.g., providing guidance or other information about an environment to disabled/impaired person.

Content may be visible, e.g., displayed on a display of device 105, or audible, e.g., produced as audio 118 by a speaker of device 105. In the case of audio content, the audio 118 may be produced in a manner such that only user 110 is likely to hear the audio 118, e.g., via a speaker proximate the ear 112 of the user or at a volume below a threshold such that nearby persons (e.g., observer's 160, 170, etc.) are unlikely to hear. In some implementations, the audio mode (e.g., volume), is determined based on determining whether other persons are within a threshold distance or based on how close other persons are with respect to the user 110.

In some implementations, the content provided by the device 105 and sensor features of device 105 may be provided using components, sensors, or software modules that are sufficiently small in size and efficient with respect to power consumption and usage to fit and otherwise be used in lightweight, battery-powered, wearable products such as wireless ear buds or other ear-mounted devices or head mounted devices (HMDs) such as smart/augmented reality (AR) glasses. Features can be facilitated using a combination of multiple devices. For example, a smart phone (connected wirelessly and interoperating with wearable device(s)) may provide computational resources, connections to cloud or internet services, location services, etc.

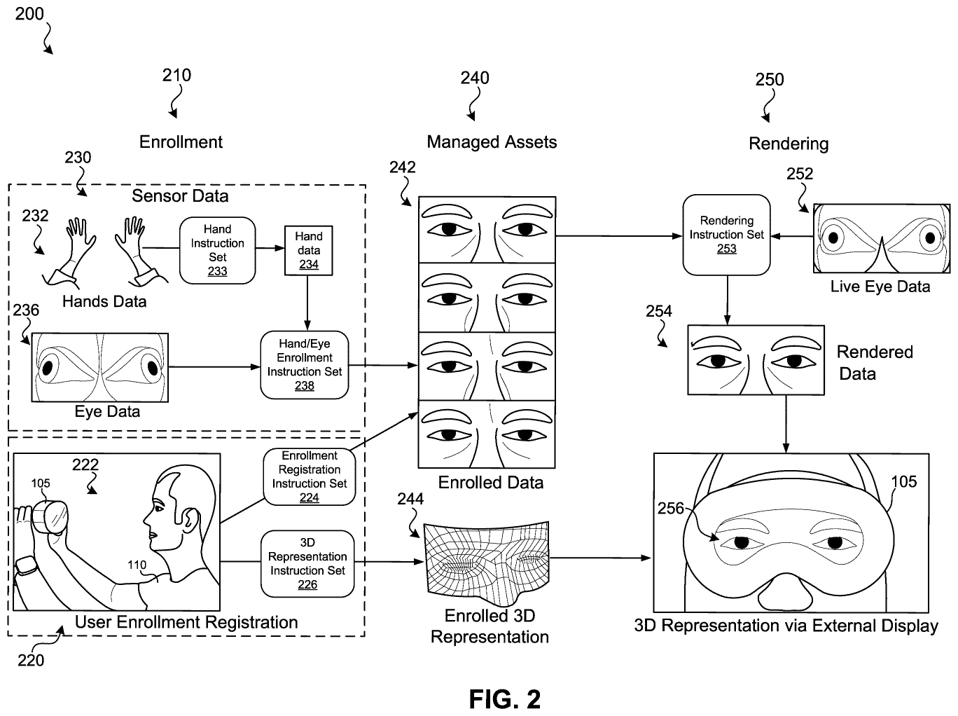

FIG. 2 illustrates an example of generating a three-dimensional (3D) representation of an eye region based on enrollment data, in accordance with some implementations. In particular, FIG. 2 illustrates an example environment 200 of a process for executing an enrollment process 210 to determine managed assets 240 and to generate a 3D representation (e.g., 3D representation 256) during a rendering process 250.

In some implementations, the enrollment process 210 includes a user enrollment registration 220 (e.g., preregistration of enrollment data) and obtaining sensor data 230 (e.g., live data enrollment). The user enrollment registration 220, as illustrated in image 222, may include a user (e.g., user 110), obtaining a full view image of his or her face using external sensors on the device 105, and therefore, would take off the device 150 and face the device 105 (e.g., an HMD) towards his or her face during an enrollment process. For example, the enrollment personification may be generated as the system obtains image data (e.g., RGB images) of the user's face while the user is providing different facial expressions. For example, the user may be told to “raise your eyebrows,” “smile,” “frown,” etc., in order to provide the system with a range of facial features for an enrollment process. An enrollment personification preview may be shown to the user via an external facing display on the device 105 while the user is providing the enrollment images to get a visualization of the status of the enrollment process. In this example, an enrollment registration instruction set 224 obtains the different expressions and sends the enrollment registration data to the enrolled data 242 of the managed assets 240 (e.g., a stored database of one or more enrollment images). In some implementations, the enrollment process 210 includes a 3D representation instruction set 226 that obtains the enrollment images and determines an enrolled 3D representation 244 of the user 110 (e.g., a predetermined 3D representation). The predetermined 3D representation (e.g., enrolled 3D representation 244) includes a plurality of vertices and polygons that may be determined at the enrollment process 210 based on image data, such as RGB data and depth data. For example, the enrolled 3D representation 244 may be a mesh of the user's face or region around the eyes generated from enrollment data (e.g., one-time pixel-aligned implicit function (P IFu) data). The predetermined 3D data, such as PIFu data, may include a highly effective implicit representation that locally aligns pixels of 2D images with the global context of their corresponding 3D object.

In some implementations, obtaining the sensor data 230 may include obtaining hands data 232 and eye data 236 in order to supplement the enrolled data 242 with different data sets that are customized to the user and during a live scanning process. For example, the hands data 232 (e.g., image data of the hands) may be analyzed by the hand instruction set 233 in order to determine hand data 234 (e.g., skin tone/color). The hand/eye enrollment instruction set 238 may then be configured to obtain the hand data 234 from the hand instruction set 233 and obtain the eye data 236 and determine more accurate color representations for the images of the face of the user for the enrolled data 242. For example, the hand/eye enrollment instruction set 238 may adjust color using a transform using a Monge-Kanorovich Color Transfer technique, or the like. In some implementations, the color transform may include reconstructing a PIFu representation in a UV space which enables a more accurate transform based on comparing colors of the corresponding user parts.

In some implementations, the rendering process 250 obtains the enrolled data 242 from the managed assets 240 and obtains the enrolled 3D representation 244 and determines a 3D representation 256 to be displayed via an external display on the device 105. For example, a rendering instruction set 253 may obtain live eye data 252 (e.g., live camera views during use of the HMD-device 105), obtain the enrolled data 242 for the different sets of managed assets, and determine rendered data 254. The rendering instruction set 253 may then determine the 3D representation 256 (e.g., a real-time representation of a portion of the user 110) by combining the enrolled 3D representation 244 and the rendered data 254. In some implementations, the rendering instruction set 253 may repeat generating the 3D representation 256 for each frame of live eye data 252 captured during each instant/frame of a live session or other experience that triggers generating the 3D representation 256 (e.g., displaying the region of the face on the external facing display when there is an observer).

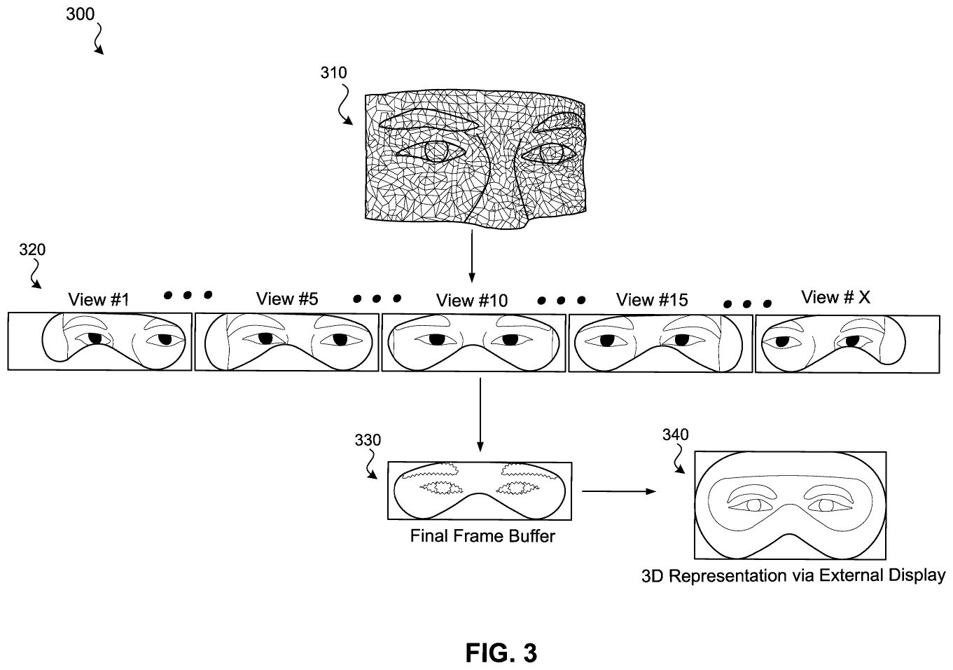

FIG. 3 illustrates an example of generating a 3D representation of an eye region based on dynamic texturing on a static mesh, in accordance with some implementations. In particular, FIG. 3 illustrates an example environment 300 to execute a rendering process (e.g., rendering process 250 of FIG. 2) for generating a 3D representation (e.g., 3D representation 340) based on dynamic texturing on a static mesh. For example, as illustrated, a predetermined 3D representation 310 (e.g., a static mesh such as enrolled 3D representation 244 from the user enrollment registration 220) is obtained, then a series of predefined views 320 are rendered (e.g., view #1 through view #X) based on the predetermined 3D representation 310. A final frame buffer 330 is determined based on interleaving all of the renderings from the predefined views 320 (e.g., dynamic texturing). The final frame buffer 330 is then utilized by a rendering instruction set to determine the 3D representation 340 to be displayed on the external display of the HMD (e.g., device 105).

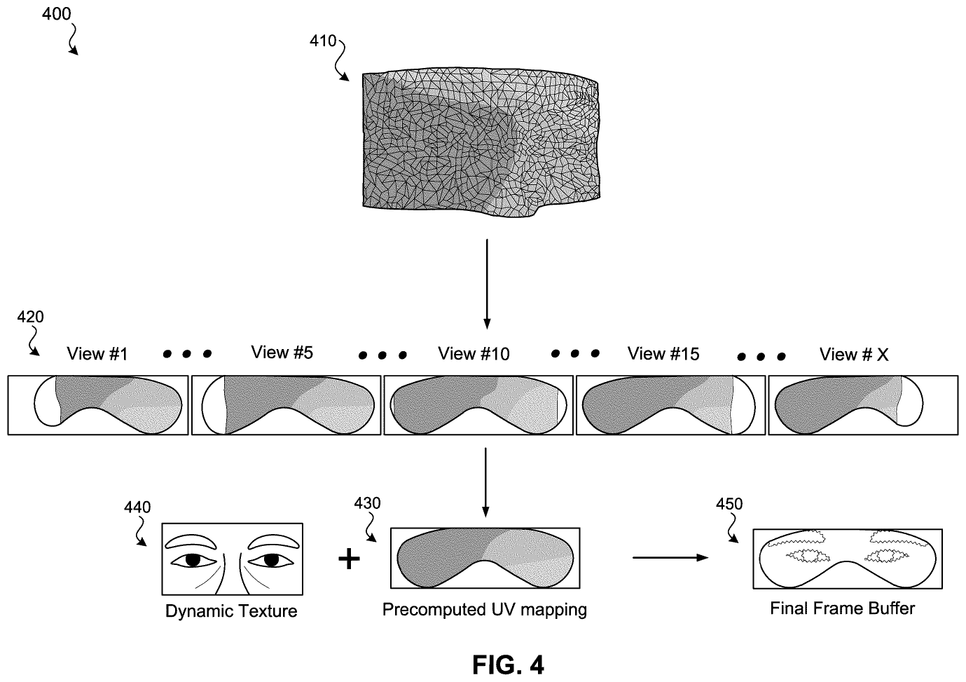

FIG. 4 illustrates an example of generating a 3D representation of an eye region based on dynamic texturing and static UVs on a static mesh, in accordance with some implementations. In particular, FIG. 4 illustrates an example environment 400 to execute a rendering process (e.g., rendering process 250 of FIG. 2) for generating a 3D representation (e.g., 3D representation 256) based on static UVs on a static mesh. For example, a 3D static UV representation 410 is obtained (e.g., static UVs on a static mesh such as a static mesh defined by the enrolled 3D representation 244 from the user enrollment registration 220). Then a series of predefined static UV views 420 are rendered (e.g., view #1 through view #X) based on the 3D static UV representation 410. A precomputed UV mapping 430 is then determined based on interleaving all of the renderings from the predefined static UV views 420. A final frame buffer 450 is then determined based on obtaining a dynamic texture 440 (e.g., rendered data 254) and using the dynamic texture 440 with the precomputed UV mapping 430 as a sample texture. The final frame buffer 450 may then be utilized by a rendering instruction set (e.g., rendering instruction set 253) to determine a 3D representation (e.g., 3D representation 340) to be displayed on the external display of the HMD (e.g., device 105).

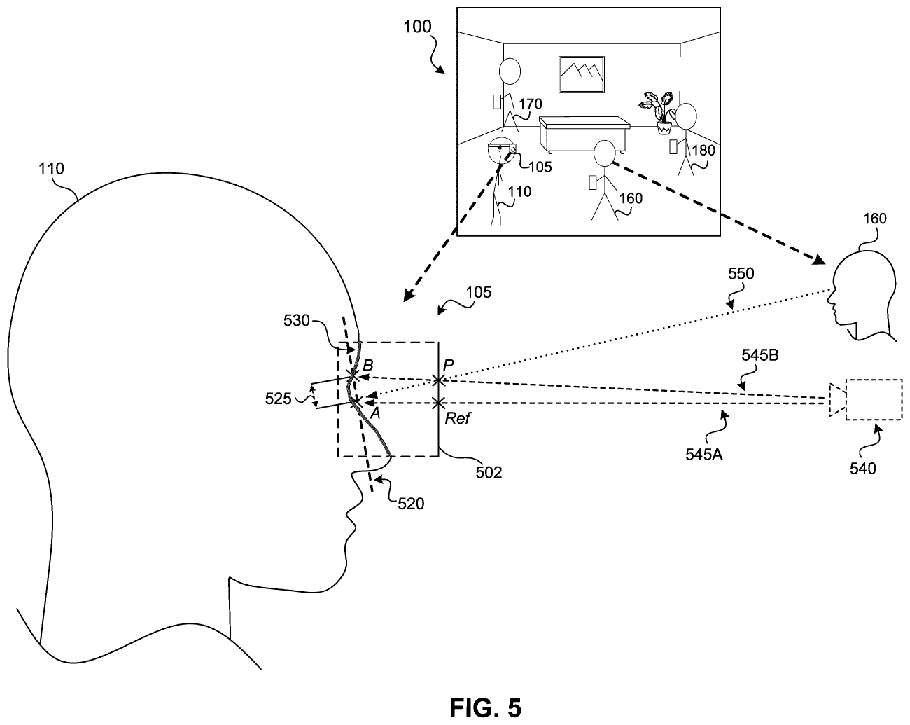

FIG. 5 illustrates an example of determining a vertical parallax offset correction based on an observer-based viewing characteristic, in accordance with some implementations. In particular, FIG. 5 illustrates analyzing the environment 100 of FIG. 1 by the device 105, an HMD, worn by user 110, in order to determine one or more observer-based viewing characteristics associated with the detected observer(s) within the environment (e.g., observer 160, observer 170, observer 180, etc.), and subsequently determine whether or not to adjust a rendered view of a 3D representation of a facial region (e.g., eye region) of the user 110. For example, the device 105 provides a 3D representation of a user's face that is generated (e.g., based on prior and/or current sensor data of the user's face) and the views of the 3D representation are rendered based on a render camera position 540 (e.g., directly in front of the HMD display) and an adjustment that is based on observer vertical viewing angle. In some implementations, the adjustment may involve determining an offset using a parallax plane.

As illustrated in FIG. 5, the render camera position 540 of the device 105 may initially generate a facial mesh representation 530 of the user based on the reference point “Ref” on the external display 502 which correlates to point “A” on the facial mesh representation 530. In other words, the initial representation generates a facial mesh representation 530 based on an initial render camera position 540 looking directly aligned and straight ahead with respect to the user 110 (e.g., standing face to face and same or similar height with an observer) as illustrated by the render camera viewpoint 545A. The device 105, using techniques described herein, may detect a first observer (e.g., observer 160), determine an observer viewing characteristic corresponding to one or more vertical viewing angles of the observer 160 relative to the device 105, and determine to render a view of the facial mesh representation 530 on the external facing display 502 based on the observer viewing characteristic by adjusting a vertical offset (e.g., adjusted for a vertical parallax correction). For example, as illustrated in FIG. 5, the device 105, using one or more sensors, detects the observer's 160 viewpoint 550 (viewing angle) towards the device 105, which is illustrated by point “P” on the external display 502 which would correlate to point “A” on the facial mesh representation 530. In some implementations, a parallax plane 520 is determined based on the facial mesh representation 530, which correlates as a plane along a vertical line between point A and point B on the facial mesh representation 530. A UV offset 525 may then be determined based on point A and point B along the parallax plane 520 in order to adjust the render camera viewpoint 545B. Thus, the render camera viewpoint 545B is adjusted based on the determined UV offset 525 to display the shifted facial mesh representation 530 with respect to the viewpoint 550 of the observer 160. In other words, the shifted facial mesh representation 530 is translated to a different position (e.g., shifted in the y-direction along the parallax plane 520 at a distance of the UV offset 525).

Some implementations account for different vertical viewing angles of multiple observers by making adjustments using an average vertical viewing angle or a weighted average vertical viewing angle (e.g., weighted based on proximity to the HMD). For example, if observer 170 and observer 180 were also relatively close to observer 160, and within the view of the user 110, then the average vertical viewing angle between each of the observers may be used to determine the UV offset 525. Some implementations account for different vertical viewing angles of multiple observers by applying a different adjustment for each observer. For example, each observer may see a different view provided by a lenticular display on an HMD that can display different views to different horizontal viewing angles. In some implementations, each such view may be adjusted based on the respective observer's vertical viewing angle. Some implementations additionally dim the views based on the vertical viewing angle. For example, increasing dimming for larger vertical viewing angle views. In some implementations, the parallax effect may supplement a 3D effect provided by a lenticular display (e.g., hybrid 3D effect). For example, the parallax effect may be designed to supplement the 3D effect provided by a lenticular display. Cylindrical lenticular lenses may only provide a 3D effect on one axis, so the parallax effect may help supplement the 3D effect on the other axis. In other words, providing a parallax effect provides a hybrid 3D effect.

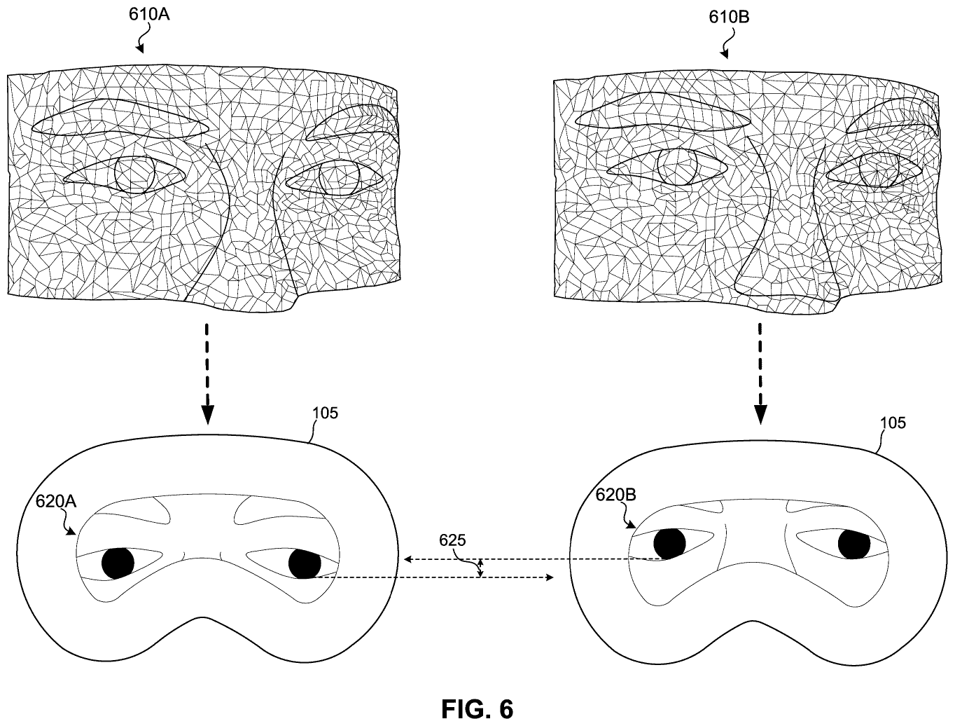

FIG. 6 illustrates an example of adjusting a view of a 3D representation on the external facing display based on a vertical offset, in accordance with some implementations. In particular, FIG. 6 illustrates generating a 3D representation 620A for a first instance of time based on a predetermined 3D representation 610A (e.g., a static mesh such as enrolled 3D representation 244 from the user enrollment registration 220) at an HMD (e.g., device 105). Moreover, FIG. 6 illustrates generating another updated 3D representation 620B for a second instance of time based on a predetermined 3D representation 610B which has been shifted by an offset 625. For example, for illustrative purposes, the dotted line at the bottom of an eye of 3D representation 620A has been shifted higher for the bottom of the eye for 3D representation 620B by a vertical offset 625. In other words, the 3D representation 620B is adjusted (e.g., shifted vertically) for a software-based vertical parallax correction to compensate for an observer-based viewing characteristic (e.g., vertical viewing angle or the like).

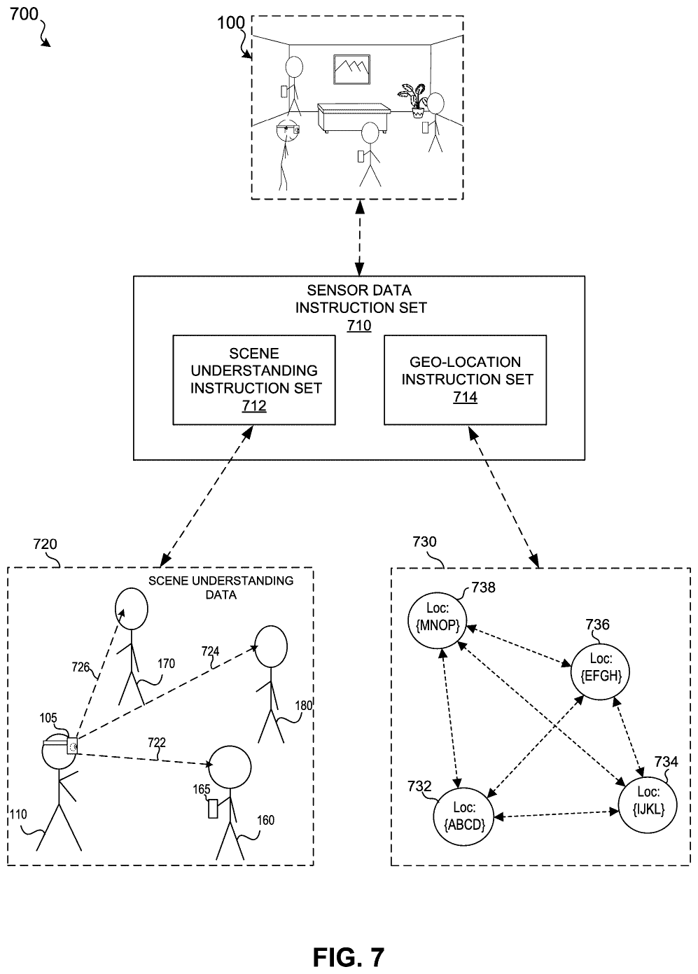

FIG. 7 illustrates exemplary electronic devices and respective users in the same physical environment and determining observer-based viewpoints in accordance with some implementations. In particular, FIG. 7 illustrates an exemplary environment 700 that includes the environment 100 of FIG. 1, determined scene understanding data 720 from a scene understanding instruction set 712 of a sensor data instruction set 710 based on sensor data of the physical environment 102. For example, the scene understanding data 720 may include an object detection map for objects, such as users/observers or other physical objects (e.g., plant 125, desk 130, etc.), of the physical environment 102. Additionally, in an exemplary implementation, the scene understanding instruction set 712 detects characteristics for each of the objects, and in particular, observer-based characteristics associated with each detected observer (e.g., other users within the view of the device 105). For example, the device 105 via one or more external sensors, detects each observer 160, 170, 180, and detects an observer-based viewpoint for each respective user (e.g., one or more vertical viewing angles). For example, the viewpoint 722 illustrates a detected viewing angle (e.g., a line-of-sight viewpoint) for observer 160, the viewpoint 724 illustrates a detected viewing angle for observer 180, and the viewpoint 726 illustrates a detected viewing angle for observer 170.

FIG. 7 further illustrates generating a location network map 730 (e.g., a mesh network map) from a geo-location instruction set 714 based on the determined locations of the devices in physical environment 102. For example, a geo-location network (e.g., mesh network) may be utilized based on the location/position data of multiple devices in a room (e.g., devices 105, 165, 175, 185, etc.), while the identity of each device is kept anonymous (e.g., via anonymization, tokenization, etc.) as an information system (e.g., a cloud based server) records and collects image content from each device. The location map 730 illustrates a two-dimensional (2D) top-down view of locations of representations of devices or other representations of objects within a 3D environment. For example, as illustrated in the location map 730, the location of device 105 as indicated by location indicator 732 is {ABCD}, the location of device 165 as indicated by location indicator 734 is {IJKL}, the location of device 175 as indicated by location indicator 738 is {MNOP}, and the location of device 185 as indicated by location indicator 736 is {EFGH}. In some implementations, each device's location may be determined and/or approximated based of another device's location at a particular time (e.g., based on the short-range sensor data, GPS coordinates, WiFi location, simultaneous localization and mapping (SLAM) localization techniques, a combination thereof, or the like). In some implementations, each device's location may be determined and/or approximated based on identifying one or more objects within the view of an acquired image(s). Additionally, or alternatively, a static object may used as anchor, such as desk 130. Thus, as new content is being obtained while the user/device is moving throughout the environment, the static object (desk) can be used as anchor when analyzing and combining different subsets of RGB image data to determine user/device location information. The collected device location and tracking data from the location network map 730 may be utilized to further enhance the detection of the observer-based viewing characteristics by tracking observers even if they move away from a current line-of-sight viewpoint of the device 105.

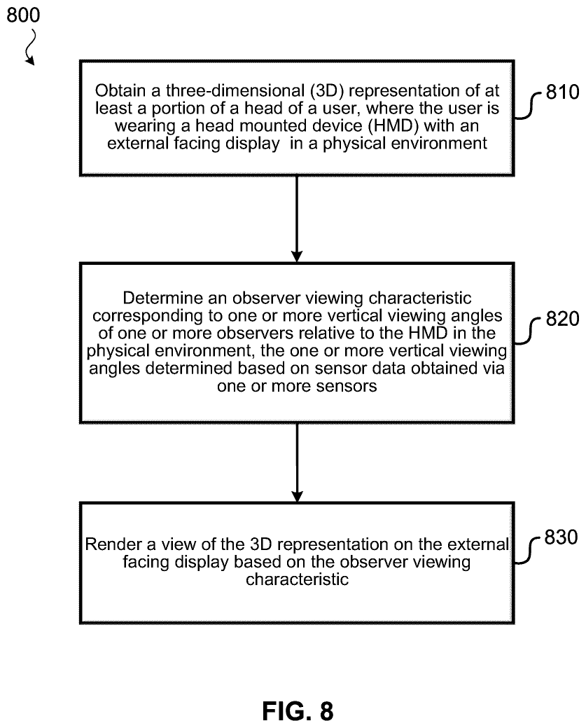

FIG. 8 is a flowchart illustrating a method 800 for rendering a view of a 3D representation on an external facing display based on a determined observer-based viewing characteristic, in accordance with some implementations. In some implementations, a device, such as electronic device 105, performs method 800. In some implementations, method 800 is performed on a mobile device, desktop, laptop, HMD, ear-mounted device or server device, or a combination thereof. The method 800 is performed by processing logic, including hardware, firmware, software, or a combination thereof. In some implementations, the method 800 is performed on a processor executing code stored in a non-transitory computer-readable medium (e.g., a memory).

In an exemplary implementation, the method 800 provides views of a 3D representation of a portion of a user on an external facing display of a device worn by a user, such as an HMD (e.g., device 105). In some implementations, the views of the portion of the user depict an eye region of a user (e.g., user 110), such as the eyes and surrounding face around the eyes. In some implementations, the views of the eye region are generated and adjusted to account for a vertical viewing angle for an observer relative to a display or render direction. Thus, the views of the eye region better align with the user's actual eye region from the viewpoint of the observer. For example, the user's eyes appear to the observer(s) to be in the right place behind the HMD rather than appearing to be too high or too low on the user's face. In other words, the method applies a software-based vertical parallax correction to provide a more realistic positioning of the depiction of the user eye region for an observer.

In some implementations, the method 800 provides a 3D representation of a user's face that is generated (e.g., based on prior and/or current sensor data of the user's face) and the views of the 3D representation are rendered based on a render camera position (e.g., directly in front of the HMD display) and an adjustment that is based on observer vertical viewing angle. In some implementations, the adjustment may involve determining an offset using a parallax plane. Some implementations account for different vertical viewing angles of multiple observers by making adjustments using an average vertical viewing angle or a weighted average vertical viewing angle (e.g., weighted based on proximity to the HMD). Some implementations account for different vertical viewing angles of multiple observers by applying a different adjustment for each observer. For example, each observer may see a different view provided by a lenticular display on an HMD that can display different views to different horizontal viewing angles. In some implementations, each such view may be adjusted based on the respective observer's vertical viewing angle. Some implementations additionally dim the views based on the vertical viewing angle. For example, increasing dimming for larger vertical viewing angle views. In some implementations, the parallax effect may supplement a 3D effect provided by a lenticular display (e.g., hybrid 3D effect). For example, the parallax effect may be designed to supplement the 3D effect provided by a lenticular display. Cylindrical lenticular lenses may only provide a 3D effect on one axis, so the parallax effect may help supplement the 3D effect on the other axis. In other words, providing a parallax effect provides a hybrid 3D effect.

At block 810, the method 800, obtains a 3D representation of at least a portion of a head of a user, where the user is wearing an HMD with an external facing display in a physical environment. For example, an HMD (e.g., device 105) obtains 3D representation 256 to be rendered on the external facing display (e.g., external display 1090). The at least the portion of the head of a user may include a face or an eye region of the face of the user. In some implementations, the 3D representation may represent the entire face or just an area around the eyes. The 3D representation may be generated using a texture/mesh that is updated every frame or slower (e.g., every other frame, every 10 frames, etc.). In some implementations, the 3D representation maybe a frame-specific 3D representation that is generated using sensor data from inward/down facing cameras.

At block 820, the method 800 determines an observer viewing characteristic corresponding to one or more vertical viewing angles of one or more observers relative to the HMD in the physical environment, the one or more vertical viewing angles is determined based on sensor data obtained via one or more sensors. For example, as illustrated in FIG. 5, an observer viewpoint 550 for observer 160 is determined, which coincides with point P on the external facing display, where the observer (observer 160) believes they are focused on point A on the user's 110 facial region. In some implementations, one or more vertical viewing angles are determined using location data of the other user's devices, and/or image data of observers from the HMD, and determining a scene understanding for context awareness, and the like. The vertical viewing angle may be relative to a plane of the display; thus, the vertical viewing angle may change as the device rotates forward/backward even if the observer is stationary.

In some implementations, the one or more vertical viewing angles of the one or more observers is relative to a plane of the external facing display. For example, the vertical viewing angle may be relative to a plane of the display, thus the vertical viewing angle may change as the device rotates forward/backward even if the observer is stationary. In some implementations, the HMD (device 105) includes one or more outward facing image sensors (e.g., camera 1036), and the one or more vertical viewing angles are determined based on sensor data captured by the one or more outward facing image sensors.

In some implementations, the one or more vertical viewing angles of the one or more observers is updated at a first frequency, and wherein the view of the 3D representation is rendered based on the observer-based viewing characteristic at a second frequency that is higher than the first frequency. For example, location data of observers may be updated at 10 hz (e.g., tracking data), but the view and/or image data of observers maybe updated every frame (e.g., 90 Hz). For example, SLAM (or other vision-based tracking techniques) may be utilized alongside the tracking, and they may be at different frequencies. In other words, if the user (e.g., wearing the HMD) moves his or her head, and an observer is stationary, then the parallax may update at 90 hz with the SLAM updates. However, when the observer is moving, and the wearer is stationary, then the update rate is based on the tracking rate (e.g., 10 hz or the like).

In some implementations, the sensor data associated with determining the one or more vertical viewing angles includes at least one of location data and image data corresponding to the one or more observers. For example, the sensor data may include location data or image analysis based on RGB and/or depth data may be used to determiner context awareness of detected observers within a physical room or within a determined region (e.g., within five meters of the device all around, or within five meters of an arcuate viewing angle from the device's perspective, such as 180 degrees towards the direction the wearer of the device is facing towards). In some implementations, determining the observer-based viewing characteristic corresponding to the one or more vertical viewing angles of the one or more observers relative to the HMD in the physical environment is based on determining a scene understanding of the physical environment. For example, as illustrated in FIG. 7, the scene understanding instruction set 712 has determined a scene understanding for context awareness of the observers.

At block 830, the method 800 renders a view of the 3D representation on the external facing display based on the observer viewing characteristic. In some implementations, rendering the view of the 3D representation on the external facing display includes adjusting a vertical offset based on the observer-based viewing characteristic. For example, as illustrated in FIG. 6, the 3D representation 620A for a first instance of time is shifted by an offset 625 (e.g., adjusted for a vertical parallax correction) as illustrated by 3D representation 620B for a second instance of time.

In some implementations, rendering the view of the 3D representation on the external facing display includes determining a parallax plane as a proxy for the 3D representation. For example, as illustrated in FIG. 5, a parallax plane 520 is determined as a mesh proxy based on the face mesh 530, and the parallax plane 520 is used for determining the UV offset 525 (e.g., a vertical parallax correction).

In some implementations, the method 800 further includes modifying the view of the 3D representation on the external facing display based on determining that there are two or more observers of the HMD. For example, some implementations account for different vertical viewing angles of multiple observers by applying a different adjustment for each observer.

In some implementations, modifying a view of the 3D representation based on determining that there are two or more observers of the HMD includes determining an average vertical viewing angle of the two or more observers, and adjusting the view of the 3D representation on the external facing display based on the average vertical viewing angle of each observer. For example, in the case of multiple observers (e.g., as illustrated in physical environment 102 of FIG. 1 with observer 160, 170, and 180), an angle/eye level may be used that is an average eye level (e.g., average angle/eye level for observer 160, 170, and 180). Additionally, or alternatively, in some implementations, if there are multiple people within the physical environment (e.g., a party) then the system may limit the averaging to only a group of people with a particular hemisphere or angled area in front of the observer 160 wearing the device 105 (within an apparent viewing angle of observer 160).

Additionally, or alternatively, in some implementations, modifying a view of the 3D representation based on determining that there are two or more observers of the HMD includes identifying a priority observer of the two or more observers based on one or more criterion, and modifying the view of the 3D representation on the external facing display based on a viewing angle corresponding to the identified priority observer. For example, each observer may be prioritized based on one or more criterion for determining the adjusted view so that the rendered view corresponds to a particular observer. For example, if the criterion is based on a closest observer, then the adjustment would account for observer 160 viewing angle. However, if the criterion is based on a higher priority/preferred observer, then if observer 180 is preferred, than the adjustment may account for observer 180 viewing angle over observer 160 viewing angle, even though observer 160 is closer.

In some implementations, the method 800 further includes modifying a first view of the 3D representation on the external facing display for a first observer of the one or more observers and modifying a second view of the 3D representation on the external facing display for a second observer of the one or more observers, wherein the second view is a different view than the first view. For example, the device may apply a different adjustment for each detected observer, e.g., each observer may see a different view provided by a lenticular display that can display different views to different horizontal viewing angles and each such view may be adjusted based on the respective observer's vertical viewing angle. In some implementations, the parallax effect may supplement a 3D effect provided by a lenticular display (e.g., hybrid 3D effect). For example, the parallax effect may be designed to supplement the 3D effect provided by a lenticular display. Cylindrical lenticular lenses may only provide a 3D effect on one axis, so the parallax effect may help supplement the 3D effect on the other axis. In other words, providing a parallax effect provides a hybrid 3D effect.

In some implementations, the method 800 further includes modifying the view of the 3D representation on the external facing display based on determining that at least one observer the one or more observers are within an observation region of the HMD. For example, based on sensor data and/or location data associated with a device of an observer, an observation distance for each observer may be determined. The observation distance for each observer may then be compared to an observation threshold distance (e.g., 3-5 meters) of the HMD (e.g., device 105). Thus, if the observer is <3-5 meters from the user (e.g., device 105), and not across the room, then, the external facing display may be adjusted with respect to that observer's viewing angle.

In some implementations, the method 800 further includes determining an amplitude of a first vertical viewing angle corresponding to a first observer; and modifying the view of the 3D representation on the external facing display by adjusting a level of luminance for the view of the 3D representation based on the determined amplitude of the first vertical viewing angle. For example, the views of the 3D representation may be adjusted in contrast (additionally dim) based on a determined vertical viewing angle of an observer (e.g., increasing dimming for larger vertical viewing angle views).

In some implementations, the method 800 further includes determining that an amplitude of a first vertical viewing angle corresponding to a first observer exceeds a threshold, and in response to determining that the amplitude of the first vertical viewing angle corresponding to the first observer exceeds a threshold, modifying the view of the 3D representation on the external facing display by providing content corresponding to the 3D representation at one or more edges of the external facing display. For example, rendering may involve an adjustment to provide content around the edges of the 3D representation for extreme angles.

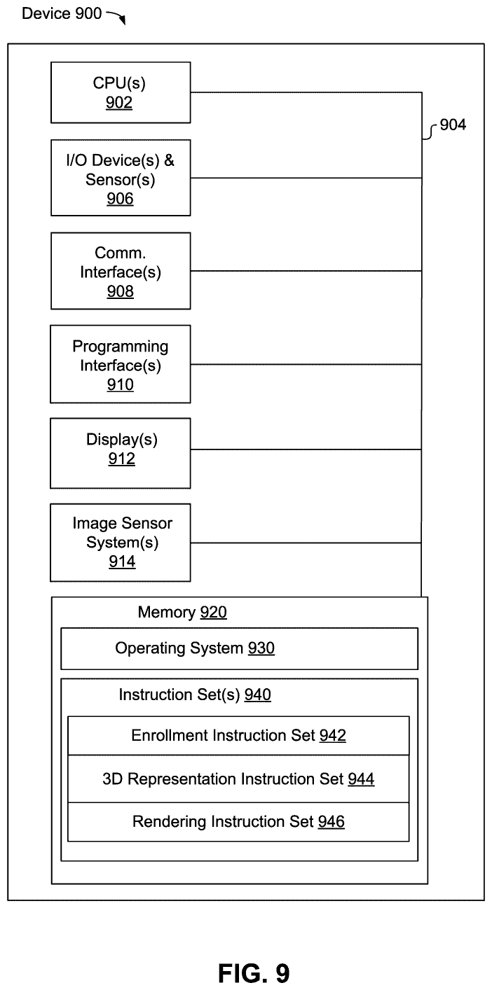

FIG. 9 is a block diagram of electronic device 900. Device 900 illustrates an exemplary device configuration for an electronic device, such as device 105, 165, 175, 185, etc. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 900 includes one or more processing units 902 (e.g., microprocessors, ASICs, FPGAs, GPUS, CPUs, processing cores, and/or the like), one or more input/output (I/O) devices and sensors 906, one or more communication interfaces 908 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 910, one or more display(s) 912 or other output devices, one or more interior and/or exterior facing image sensor systems 914, a memory 920, and one or more communication buses 904 for interconnecting these and various other components.

In some implementations, the one or more communication buses 904 include circuitry that interconnects and controls communications between system components. In some implementations, the one or more I/O devices and sensors 906 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output display(s) 912 include one or more displays configured to present a view of a 3D environment to the user. In some implementations, the one or more display(s) 912 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 900 includes a single display. In another example, the device 900 includes a display for each eye of the user.

In some implementations, the one or more output display(s) 912 include one or more audio producing devices. In some implementations, the one or more output display(s) 912 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output display(s) 912 may additionally or alternatively be configured to generate haptics.

In some implementations, the one or more image sensor systems 914 are configured to obtain image data that corresponds to at least a portion of a physical environment. For example, the one or more image sensor systems 914 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 914 further include illumination sources that emit light, such as a flash. In various implementations, the one or more image sensor systems 914 further include an on-camera image signal processor (ISP) configured to execute a plurality of processing operations on the image data.

The memory 920 includes high-speed random-access memory, such as DRAM, SRAM, DDR RAM, or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 includes a non-transitory computer readable storage medium.

In some implementations, the memory 920 or the non-transitory computer readable storage medium of the memory 920 stores an optional operating system 930 and one or more instruction set(s) 940. The operating system 930 includes procedures for handling various basic system services and for performing hardware dependent tasks. In some implementations, the instruction set(s) 940 include executable software defined by binary information stored in the form of an electrical charge. In some implementations, the instruction set(s) 940 are software that is executable by the one or more processing units 902 to carry out one or more of the techniques described herein.

The instruction set(s) 940 includes an enrollment instruction set 942, a 3D representation instruction set 944, and a rendering instruction set 946. The enrollment instruction set 942 may be configured to, upon execution, execute an enrollment registration process as described herein. The 3D representation instruction set 944 may be configured to, upon execution, determine a 3D representation as described herein. The rendering instruction set 946 may be configured to, upon execution, determine content and/or rendering instructions for a device as described herein. The instruction set(s) 940 may be embodied as a single software executable or multiple software executables.

Although the instruction set(s) 940 are shown as residing on a single device, it should be understood that in other implementations, any combination of the elements may be located in separate computing devices. Moreover, the FIG. is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

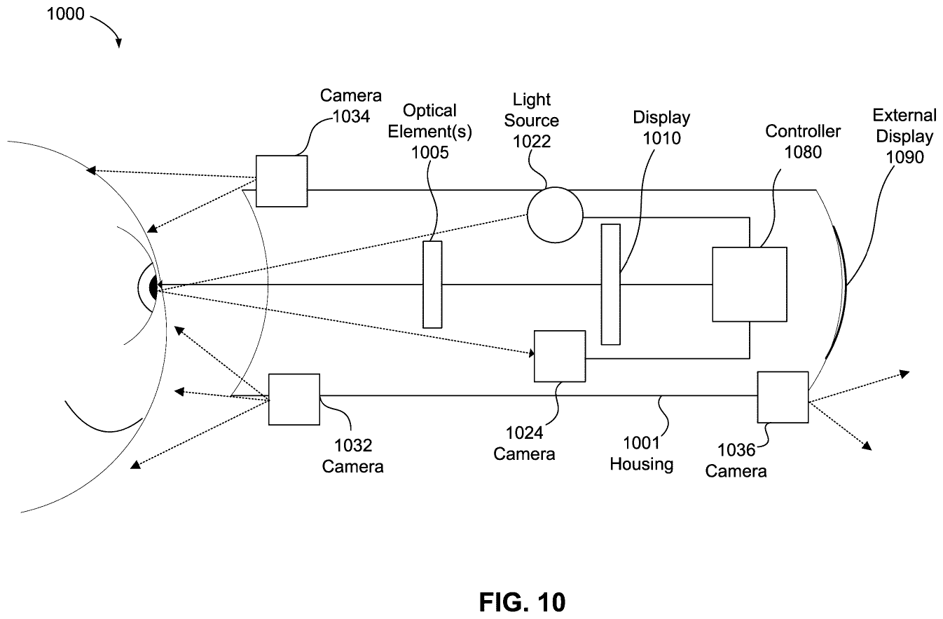

FIG. 10 illustrates a block diagram of an exemplary head-mounted device 1000 in accordance with some implementations. The head-mounted device 1000 includes a housing 1001 (or enclosure) that houses various components of the head-mounted device 1000. The housing 1001 includes (or is coupled to) an eye pad (not shown) disposed at a proximal (to the user 110) end of the housing 1001. In various implementations, the eye pad is a plastic or rubber piece that comfortably and snugly keeps the head-mounted device 1000 in the proper position on the face of the user 110 (e.g., surrounding the eye of the user 110).

The housing 1001 houses a display 1010 that displays an image, emitting light towards or onto the eye of a user 110. In various implementations, the display 1010 emits the light through an eyepiece having one or more optical elements 1005 that refracts the light emitted by the display 1010, making the display appear to the user 110 to be at a virtual distance farther than the actual distance from the eye to the display 1010. For example, optical element(s) 1005 may include one or more lenses, a waveguide, other diffraction optical elements (DOE), and the like. For the user 110 to be able to focus on the display 1010, in various implementations, the virtual distance is at least greater than a minimum focal distance of the eye (e.g., 7 cm). Further, in order to provide a better user experience, in various implementations, the virtual distance is greater than 1 meter.

In some implementations, the housing 1001 houses an external display 1090 that displays an image. In some implementations, the external display 1090 includes one or more displays configured to present a view of a 3D representation of a portion of the user of device 1000 (e.g., an eye region) to the outside physical environment (e.g., to one or more observers within the physical environment). In some implementations, the external display 1090 corresponds to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays of the external display 1090 correspond to diffractive, reflective, polarized, holographic, etc. waveguide displays.

The housing 1001 also houses a tracking system including one or more light sources 1022, camera 1024, camera 1032, camera 1034, camera 1036, and a controller 1080. The one or more light sources 1022 emit light onto the eye of the user 110 that reflects as a light pattern (e.g., a circle of glints) that may be detected by the camera 1024. Based on the light pattern, the controller 1080 may determine an eye tracking characteristic of the user 110. For example, the controller 1080 may determine a gaze direction and/or a blinking state (eyes open or eyes closed) of the user 110. As another example, the controller 1080 may determine a pupil center, a pupil size, or a point of regard. Thus, in various implementations, the light is emitted by the one or more light sources 1022, reflects off the eye of the user 110, and is detected by the camera 1024. In various implementations, the light from the eye of the user 110 is reflected off a hot mirror or passed through an eyepiece before reaching the camera 1024.

The display 1010 emits light in a first wavelength range and the one or more light sources 1022 emit light in a second wavelength range. Similarly, the camera 1024 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 110 selects an option on the display 1010 by looking at it), provide foveated rendering (e.g., present a higher resolution in an area of the display 1010 the user 110 is looking at and a lower resolution elsewhere on the display 1010), or correct distortions (e.g., for images to be provided on the display 1010).

In various implementations, the one or more light sources 1022 emit light towards the eye of the user 110 which reflects in the form of a plurality of glints.

In various implementations, the camera 1024 is a frame/shutter-based camera that, at a particular point in time or multiple points in time at a frame rate, generates an image of the eye of the user 110. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1024 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1032, camera 1034, and camera 1036 are frame/shutter-based cameras that, at a particular point in time or multiple points in time at a frame rate, may generate an image of the face of the user 110 or capture an external physical environment. For example, camera 1032 captures images of the user's face below the eyes, camera 1034 captures images of the user's face above the eyes, and camera 1036 captures the external environment of the user (e.g., environment 100 of FIG. 1). The images captured by camera 1032, camera 1034, and camera 1036 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws.

It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a head mounted device (HMD) comprising one or more sensors and an external facing display:
obtaining a three-dimensional (3D) representation of at least a portion of a head of a user, wherein the user is wearing the HMD in a physical environment;
determining an observer-based viewing characteristic corresponding to one or more vertical viewing angles of one or more observers relative to the HMD in the physical environment, the one or more vertical viewing angles determined based on sensor data obtained via the one or more sensors; and
rendering a view of the 3D representation on the external facing display, the view of the 3D representation rendered based on the observer-based viewing characteristic.

2. The method of claim 1, wherein rendering the view of the 3D representation on the external facing display comprises adjusting a vertical offset based on the observer-based viewing characteristic.

3. The method of claim 1, wherein rendering the view of the 3D representation on the external facing display comprises determining a parallax plane as a proxy for the 3D representation.

4. The method of claim 1, wherein the one or more vertical viewing angles of the one or more observers is relative to a plane of the external facing display.

5. The method of claim 1, wherein the one or more vertical viewing angles of the one or more observers is updated at a first frequency, and wherein the view of the 3D representation is rendered based on the observer-based viewing characteristic at a second frequency that is higher than the first frequency.

6. The method of claim 1, further comprising:
modifying the view of the 3D representation on the external facing display based on determining that there are two or more observers of the HMD.

7. The method of claim 6, wherein modifying the view of the 3D representation based on determining that there are two or more observers of the HMD comprises:
determining an average vertical viewing angle of the two or more observers; and
adjusting the view of the 3D representation on the external facing display based on the average vertical viewing angle of each observer.

8. The method of claim 6, wherein modifying the view of the 3D representation based on determining that there are two or more observers of the HMD comprises:
identifying a priority observer of the two or more observers based on one or more criterion; and
modifying the view of the 3D representation on the external facing display based on a viewing angle corresponding to the identified priority observer.

9. The method of claim 1, further comprising:
modifying a first view of the 3D representation on the external facing display for a first observer of the one or more observers; and
modifying a second view of the 3D representation on the external facing display for a second observer of the one or more observers, wherein the second view is a different view than the first view.

10. The method of claim 1, further comprising:
modifying the view of the 3D representation on the external facing display based on determining that at least one observer the one or more observers are within an observation region of the HMD.

11. The method of claim 1, further comprising:
determining an amplitude of a first vertical viewing angle corresponding to a first observer; and
modifying the view of the 3D representation on the external facing display by adjusting a level of luminance for the view of the 3D representation based on the determined amplitude of the first vertical viewing angle.

12. The method of claim 1, further comprising:
determining that an amplitude of a first vertical viewing angle corresponding to a first observer exceeds a threshold; and
in response to determining that the amplitude of the first vertical viewing angle corresponding to the first observer exceeds a threshold, modifying the view of the 3D representation on the external facing display by providing content corresponding to the 3D representation at one or more edges of the external facing display.

13. The method of claim 1, wherein the sensor data associated with determining the one or more vertical viewing angles comprises at least one of location data and image data corresponding to the one or more observers.

14. The method of claim 1, wherein determining the observer-based viewing characteristic corresponding to the one or more vertical viewing angles of the one or more observers relative to the HMD in the physical environment is based on determining a scene understanding of the physical environment.

15. The method of claim 1, wherein the 3D representation represents a region associated with eyes of the user.

16. The method of claim 1, wherein the HMD comprises one or more outward facing image sensors, and wherein the one or more vertical viewing angles are determined based on sensor data captured by the one or more outward facing image sensors.

17. A head mounted device (HMD) comprising:
one or more sensors;
an external facing display;
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations of:
obtaining a three-dimensional (3D) representation of at least a portion of a head of a user, wherein the user is wearing the HMD in a physical environment;
determining an observer-based viewing characteristic corresponding to one or more vertical viewing angles of one or more observers relative to the HMD in the physical environment, the one or more vertical viewing angles determined based on sensor data obtained via the one or more sensors; and
rendering a view of the 3D representation on the external facing display, the view of the 3D representation rendered based on the observer-based viewing characteristic.

18. The head mounted device of claim 17, wherein rendering the view of the 3D representation on the external facing display comprises adjusting a vertical offset based on the observer-based viewing characteristic.

19. The head mounted device of claim 17, wherein rendering the view of the 3D representation on the external facing display comprises determining a parallax plane as a proxy for the 3D representation.

20. A non-transitory computer-readable storage medium, storing program instructions executable on a head mounted device (HMD) comprising one or more sensors and an external facing display, to perform operations comprising:
obtaining a three-dimensional (3D) representation of at least a portion of a head of a user, wherein the user is wearing the HMD in a physical environment;
determining an observer-based viewing characteristic corresponding to one or more vertical viewing angles of one or more observers relative to the HMD in the physical environment, the one or more vertical viewing angles determined based on sensor data obtained via the one or more sensors; and
rendering a view of the 3D representation on the external facing display, the view of the 3D representation rendered based on the observer-based viewing characteristic.
